(19) United States
(12) Patent Application Publication
(10) Pub. No.: US 2014/0160296 A1
(43) Pub. Date: Jun. 12, 2014

(54) DISTANCE MIRROR TELEVISION (DMTV) APPARATUS AND METHOD THEREOF

(71) Applicant: Ellen Tara Kaplan, New York, NY (US)

(72) Inventor: Ellen Tara Kaplan, New York, NY (US)

(21) Appl. No.: 14/178,246

(22) Filed: Feb. 11, 2014

Related U.S. Application Data
(63) Continuation-in-part of application No. 13/662,372, filed on Oct. 26, 2012, now abandoned.

(51) Int. Cl. H04N 7/18

(52) U.S. Cl. CPC H04N 7/181
USPC 348/159

(57) ABSTRACT

The present invention relates generally to a dual mono-directional media apparatus and method thereof. More particularly, the invention is directed to a method and apparatus relating to a dual mono-directional television apparatus and method thereof. More specifically, the present invention is also directed to a “Distance Mirror Television” (DMTV) apparatus and method thereof. Images from a first location are captured, transmitted, and broadcast to a second location, while simultaneously images from the second location are captured, transmitted, and broadcast to the first location. The method of use allows mutual, simultaneous, live observation, between individuals at different locations. Optionally, the first location could also broadcast sound from the second location along with the incoming images from the second location, and similarly, the second location could also broadcast sound from the first location along with the incoming images from the first location.

### CROSS-REFERENCE TO RELATED APPLICATION

The instant patent application is a Continuation-In-Part and claims priority to and the benefit of pending U.S. patent application Ser. No. 13/662,372, filed on Oct. 26, 2012, titled “Distance Mirror Television Apparatus And Method Thereof,” the entire disclosure of which patent application is incorporated herein by reference.

### FIELD OF THE INVENTION

The present invention relates generally to a dual mono-directional media apparatus and method thereof. More particularly, the invention is directed to a method and apparatus relating to a dual mono-directional television apparatus and method thereof. More specifically, the present invention is also directed to a “Distance Mirror Television” (DMTV) apparatus and method thereof. Images from a first location are captured, transmitted, and broadcast to a second location, while simultaneously images from the second location are captured, transmitted, and broadcast to the first location. The method of use allows mutual, simultaneous, live observation, between individuals at different locations. Optionally, the first location could also broadcast sound from the second location along with the incoming images from the second location, and similarly, the second location could also broadcast sound from the first location along with the incoming images from the first location.

### BACKGROUND INFORMATION

Improvements have been made in the past on the basic design and utility of a television type device. Similarly, methods have been devised to further the art of television type devices.

Past efforts have included inventions that made use of a deliberately closed and limited system of broadcast and reception, such as, for example, Closed Circuit Television (CCTV).

Closed Circuit Television (CCTV) provides a real-time virtual image, generally but not necessarily of something distant, to specific monitor(s) at specific location(s).

Closed circuit television now provides uses in surveillance; observation or monitoring or control of goings-on or procedures from a vantage point; distance conferencing; distance education.

There are also personal or idiosyncratic uses of Closed Circuit Television (CCTV), such as pay-per-view and video art.

There are also uses wherein Closed Circuit Television (CCTV) provides a real time virtual image of its viewer(s), allowing them to observe themselves, such as, at a bank, or at a customer service center.

There are also mutual uses on the Internet and other computer networks, for example, voice-and-view uses using multimedia applications. For example, Skype visuals accompany conversations and meetings.

In recent decades the explosion of wireless technologies has inspired and supported innovations in Video Conferencing (VC) or Video Chatting (VC). Many means and methods of real-time mutual virtual contact through Video Conferencing or Video Chatting now exist.

U.S. Pat. No. 5,305,100 (Hyeon J. Choi), the entire disclosure of which is incorporated herein by reference, discloses a bidirectional communication system for a CCTV in a monitoring system having a plurality of monitoring cameras, comprising a plurality of rotators, each for rotating a corresponding one of the plurality of cameras in vertical and horizontal directions in response to upward, downward, left and right rotation control signals, a plurality of voice transmission and reception adapters, each mounted to a corresponding one of the plurality of cameras, for transmitting and receiving a voice signal, a plurality of remote controllers, each having a transmitter and a receiver for transmitting and receiving the voice signal remotely through a corresponding one of the plurality of voice transmission and reception adapters, a video selector for selecting a desired one of video signals from the plurality of cameras, a channel selector for selecting a desired channel for voice communication and camera rotation control, a voice processing circuit for performing transmission and reception of the voice signal through the plurality of voice transmission and reception adapters, and a rotator control circuit for generating the upward, downward, left and right rotation control signals for controlling actuation of the plurality of rotators, thereby to control projection angles of the plurality of cameras.

U.S. Pat. No. 6,529,230 (Yuen Thub William Chong), the entire disclosure of which is incorporated herein by reference, discloses an invention that relates to a remote surveillance and conferencing system which includes video transceivers and provides audiovisual communications over a standard Public Switched Telephone Network (PSTN). The system provides capabilities for closed circuit television (CCTV) applications, security systems, video conferencing, remote video surveillance, home automation and fire control, all in one, without requiring use of a computer. Each video transceiver includes a dedicated keypad which allows users to use the system without a telephone. Keypad controllers available to some of the video transceivers provide a capability to remotely control the system.

U.S. Patent Publication No. 2004/0212679 (Ho-Jin Jun), the entire disclosure of which is incorporated herein by reference, discloses a closed circuit television (CCTV) system controlled by a control program installed in a remote surveillance computer, and a matrix switcher used for the CCTV system. The computer-based remote surveillance CCTV system is comprised of a computer video matrix switcher for processing an image signal from a camera and transmitting the processed signal to a video input terminal of the surveillance computer; and a control program, installed in the surveillance computer, for controlling the operation of the computer video matrix switcher and creating camera control data.

U.S. Patent Publication No. 2005/0200486 (Richard S. Greer), the entire disclosure of which is incorporated herein by reference, discloses a clinical (or other) event which triggers automatic video recording of an area in the vicinity of a patient on a DVR (Digital Video Recorder) by a CCTV (Closed Circuit Television) for storage in an Electronic Patient Record (EPR) using coded data (e.g., identifying event type, date, time, duration) and alerts medical personnel to events requiring intervention. A system for remote monitoring of a patient, includes a video camera positioned for monitoring a patient care area. A camera management processor initiates activation of image acquisition by the camera in response to detection of a signal derived in response to a trigger condition. A video recording unit stores data representing acquired video images in response to camera activation.

U.S. Patent Publication No. 2008/0298571 (Andrew F. Kurtz, et al.), the entire disclosure of which is incorporated herein by reference, discloses a video communication (VC) system and method for operating a video communication (VC) system. The video communication system has a video communication device, having an image display device and at least one image capture device, wherein the at least one image capture device acquires video images of a local environment and an individual therein, according to defined video capture settings, an audio system having an audio emission device and an audio capture device; and a computer operable to interact with a contextual interface, a privacy interface, an image processor, and a communication controller to enable a communication event including at least one video scene in which outgoing video images are sent to a remote site. Wherein the contextual interface includes scene analysis algorithms for identifying potential scene transitions and capture management algorithms for providing changes in video capture settings appropriate to any identified scene transitions; and wherein the privacy interface provides privacy settings to control the capture, transmission, display, or recording of video image content from the local environment.

U.S. Patent Publication No. 2011/0249073 (Elizabeth C. Cranfill, et al.), the entire disclosure of which is incorporated herein by reference, discloses a method for initiating a video conference (VC) using a first mobile device. The method presents, during an audio call through a wireless communication network with a second device, a selectable user-interface (UI) item on the first mobile device for switching from the audio call to the video conference (VC). The method receives a selection of the selectable UI item. The method initiates the video conference (VC) without terminating the audio call. The method terminates the audio call before allowing the first and second devices to present audio and video data exchanged through the video conference (VC).

The present invention improves on the prior art by providing an inventive “Distance Mirror Television” (DMTV) apparatus and method thereof.

### PURPOSES AND SUMMARY OF THE INVENTION

The invention is a “Distance Mirror Television” (DMTV) apparatus and method thereof.

One purpose of DMTV (Distance Mirror Television) is to mimic the Mirror but remake it in an essential respect. The virtual reality of oneself in the mirror is changed into something else. DMTV allows a first person in a first place to look into a mirror-like object and see another person in another place, while knowing that this other person in another place is looking back at him/her. This double mutual observation between different people in different places or locations is maintained by an automatic, continuous transmission.

The DMTV transmission provides images from a first location to a second location, and images from a second location to the first location at the same time.

The DMTV transmission captures live images from a first location and displays them at a second location, while simultaneously displaying live images captured from the second location at the first location.

The DMTV transmission may broadcast, when desired, live background sound from the first location at a second location, and simultaneously broadcast at the first location live background sound arising from the second location.

The DMTV transmission allows mutual, simultaneous, real-time, live observation between individuals at different locations.

The DMTV transmission allows for a succession of real-time live mutual observations between individuals at different locations.

The DMTV transmission allows real-time, live, mutual observations between individuals at stationary and/or non-stationary locations.

Therefore, in one aspect this invention comprises a distance mirror television apparatus, comprising:

(a) at least one first location having at least one first screen, and wherein said at least one first location has at least one first camera to record and transmit at least one first image of at least one first activity to at least one transmitter;

(b) at least one second location having at least one second screen, and wherein said at least one second location has at least one second camera to record and transmit at least one second image of at least one second activity to said at least one transmitter;

(c) said transmitter having at least one means to transmit said at least one first image to said at least one second screen at said at least one second location, and wherein said at least one second screen has at least one means to display said at least one first image at said at least one second location;

(d) said transmitter having at least one means to transmit said at least one second image to said at least one first screen at said at least one first location, and wherein said at least one first screen has at least one means to display said at least one second image at said at least one first location;

(e) wherein there is no coordination between transmission of said at least one first image, and transmission of said at least one second image;

(f) wherein there is no coordination between said at least one first activity, and said at least one second activity, and

(g) wherein there is passive observation of said at least one first activity at said second location, and a passive observation of said at least one second activity at said first location.

In another aspect this invention comprises a distance mirror television apparatus, comprising:

(a) at least one first location having at least one first screen, and wherein said at least one first location has at least one first camera to record and transmit at least one first image of at least one first activity to at least one transmitter;

(b) at least one second location having at least one second screen, and wherein said at least one second location has at least one second camera to record and transmit at least one second image of at least one second activity to said at least one transmitter;

(c) said transmitter having at least one means to transmit said at least one first image to said at least one second screen at said at least one second location, and wherein said at least one second screen has at least one means to display said at least one first image at said at least one second location;

(d) said transmitter having at least one means to transmit said at least one second image to said at least one first screen at said at least one first location, and wherein said at least one first screen has at least one means to display said at least one second image at said at least one first location;

(e) at least one first individual at said at least one first location observes said at least one second activity on said at least one first screen at said at least one first location;

(f) at least one second individual at said at least one second location observes said at least one first activity on said at least one second screen at said at least one second location;

(g) wherein there is no coordination between transmission of said at least one first image, and transmission of said at least one second image;

(h) wherein there is no coordination between said at least one first activity, and said at least one second activity;

(i) wherein said at least one first individual does not control said first transmission, and wherein said at least one second individual does not control said second transmission; and

(j) wherein there is passive observation of said at least one first activity at said second location by said second individual, and a passive observation of said at least one second activity at said first location by said first individual.

In yet another aspect this invention comprises a method to operate a distance mirror television, comprising the steps of:

(a) providing at least one first screen and at least one first camera at at least one first location;

(b) providing at least one means to said at least one first camera to record and transmit at least one first image of at least one first activity taking place at said at least one first location to at least one transmitter;

(c) providing at least one second screen and at least one second camera at at least one second location;

(d) providing at least one means to said at least one second camera to record and transmit at least one second image of at least one second activity taking place at said at least one second location to said at least one transmitter;

(e) providing at least one means to said at least one transmitter to transmit said at least one first image of said at least one first activity to said at least one second screen at said at least one second location;

(f) providing at least one means to said at least one second screen to display said at least one first image of said at least one first activity at said at least one second location;

(g) providing at least one means to said at least one transmitter to transmit said at least one second image of said at least one second activity to said at least one first screen at said at least one first location;

(h) providing at least one means to said at least one first screen to display said at least one second image of said at least one second activity at said at least one first location;

(i) at least one first individual at said at least one first location observing said at least one second activity on said at least one first screen at said at least one first location;

(j) at least one second individual at said at least one second location observing said at least one first activity on said at least one second screen at said at least one second location;

(k) wherein there is no coordination between transmission of said at least one first image and transmission of said at least one second image;

(l) wherein there is no coordination between said at least one first activity and said at least one second activity;

(m) wherein said at least one first individual does not control said first transmission, and wherein said at least one second individual does not control said second transmission; and

(n) wherein there is passive observation of said at least one first activity at said second location by said second individual, and a passive observation of said at least one second activity at said first location by said first individual.

### BRIEF DESCRIPTION OF THE DRAWINGS

Although the scope of the present invention is much broader than any particular embodiment, a detailed description of the preferred embodiment follows, together with drawings. These drawings are for illustration purposes only and are not drawn to scale. Like numbers represent like features and components in the drawings. The invention may best be understood by reference to the ensuing detailed description in conjunction with the drawings in which:

FIG. 1, illustrates a first embodiment of the inventive Distance Mirror Television (DMTV) invention.

FIG. 2, illustrates a second embodiment of the inventive Distance Mirror Television (DMTV) invention.

FIG. 3, illustrates a third embodiment of the inventive Distance Mirror Television (DMTV) invention.

FIG. 4, illustrates a fourth embodiment of the inventive Distance Mirror Television (DMTV) invention.

### DETAILED DESCRIPTION OF THE INVENTION

It should be appreciated that Closed Circuit Television (CCTV), Video Conferencing (VC) or Video Chatting (VC) or Video Communication (VC), and Distance Mirror Television (DMTV), all differ from one another. For example, the CCTV system, once set, continues to transmit, receive, and display the image from the camera on a screen, without any time limit, and this continues until either the operator decides to turn the system off or the system is shut down, such as, for repair or maintenance. Whereas, in VC, the transmission, receipt, and display, at each location exists for a limited period of time. This time duration in VC is controlled by at least one of the parties. For example, in VC the party transmitting at a first location could stop transmission from the first location, or could stop viewing the incoming transmission from the second location, or likewise the party transmitting at a second location could stop transmission from the second location, or stop viewing the incoming transmission from the first location, or either party could terminate the entire transmission once the purpose of the transmission has been served. Whereas, with DMTV transmission neither the party at a first location nor the party at a second location controls the transmission, receipt, or display, and thus once DMTV has been set up it is automatic, continuous, and open-ended. DMTV transmission would be OFF only when being serviced.

Additionally, CCTV, VC, and DMTV, are all different from each other in that, for example, in CCTV, the operator or observer selects a camera image or location or a person to observe, and the person under observation has no control over this one-way transmission, while active observation and control belongs to the operator or observer. Whereas, in VC there is a specific mutual purpose for each transmission, and all parties have control over the transmission. Additionally, in VC once the transmission has been initiated by the first party, the second party has a choice either to accept the transmission or to reject the invitation to communicate with the first party: this is akin to a telephone call, where the receiver may choose to accept the incoming call or reject it by not answering the telephone. However, selections and options such as these are not present in DMTV, as neither the first person at the first location nor the second person at the second location selects or controls the content that is captured, transmitted, and viewed at the other location.

Furthermore, CCTV, VC, and DMTV, are all different from each other in that, for example, in CCTV, the operator or observer has chosen to watch a monitor or screen to observe what is being received from one or more camera(s). And thus, in CCTV the actively monitoring operator or observer is a constant, while the contents under observation may be continuously changing. Whereas, in VC both parties, at each end, have at least some relationship with each other, and hence have some reason or desire to communicate, and thus when the transmission is established between participants of a VC (i.e., video conferencing or video chat), all parties are willing participants in the communication, and some relationship is established. That relationship could be familial, educational, work-related, recreational, telemarketing, etc. Whereas in DMTV a first party at a first location has no relationship with a second party at a second location. And while the first party is at the first location, what the first party is doing at the first location is observing the transmitted image of the second party, and similarly, what the second party is doing at the second location is observing the transmitted image of the first party. Thus, under DMTV there is no relationship established between the first party at the first location and the second party at the second location. Additionally, under DMTV, in the absence of relationship between the parties at each location, the parties at each location would be constantly changing during the uninterrupted or continuous transmission.

It is well known that in VC all the parties have control over their video cameras and/or still picture cameras and/or are providing feedback and/or are eliciting responses, and overall choosing and creating the content of the communication until one or more of the parties chose to end the communication.

The present invention, Distance Mirror Television (DMTV), uses a closed circuit type of transmission to change and amplify the mirror, and creates an electronic mirror. The Distance Mirror Television effect builds on our familiarity with mirrors and our expectation of seeing ourselves and our surroundings in the mirror. The DMTV mutual mirror invention replaces self-observation with mutual observation; instead of looking at themselves, DMTV-mirror viewers look at each other. Live, mutual closed circuit transmission is used to effect the change from what one expects of the mirror (a continuous virtual image of whatever is in front of it) to what one sees in DMTV mutual mirrors: a continuous virtual image of whatever is in front of a distant DMTV camera. But this distant continuous reality is as close as any mirror image. The mirror gaze is no longer shared with oneself, but up close with other people in other places. Distance Mirror Television produces a contemporary electronic mirror that is able to take us “through the looking glass.”

Today there is an enormous variety of ways to achieve mutual virtual contact. Means and methods of VC mutual virtual communication comprise user-initiation and user-control. In VC users are an intrinsic part of the creation of the communication. Indeed, with mobile devices, camera, screen, and user in VC could be said to form a coordinated unit, functioning together. Moreover, in VC some means and methods of computerized mutual video also incorporate algorithms and settings that are devised and revised to suit particular users. In VC algorithms and variable settings control outcomes, and coordinate outcomes to the needs and wishes of particular users.

Generally speaking, users of VC create a closed mutual broadcast that has a specific or an expected purpose or result between/among people known to each other or chosen by each other. Within this overall structure, participants at each end in VC are actively generating the communication. In VC all of the aforesaid demonstrates active control and coordination.

In distinction, control and coordination is not part of DMTV. The behavior of the DMTV apparatus is autonomous, and is outside the participants' control.

The individuals in front of DMTV cameras and screens do not work or operate DMTV. Nor does DMTV work itself to suit the individuals who are observing or being observed at each location. No component part of DMTV governs, controls, or adjusts the outcome.

DMTV builds on the Mirror. To begin with, the image on DMTV mirror screen, like any mirror, would be available to anyone who passes in front of it (although the image is coming from another location). Furthermore, in similarity to traditional mirrors, the DMTV mutual mirror (screen) is a passive object that is not controlled by any individual but functions by itself. Furthermore, DMTV transmission is continuous, in similarity to the constant virtual image of traditional mirrors.

Distance Mirror Television is meant to serve a different area of life experience than personal computer communication devices serve. Through its resemblance to mirrors, DMTV is meant to present the existence of others in an especially immediate way. DMTV is meant to provide its own novel mental, social, and aesthetic experiences.

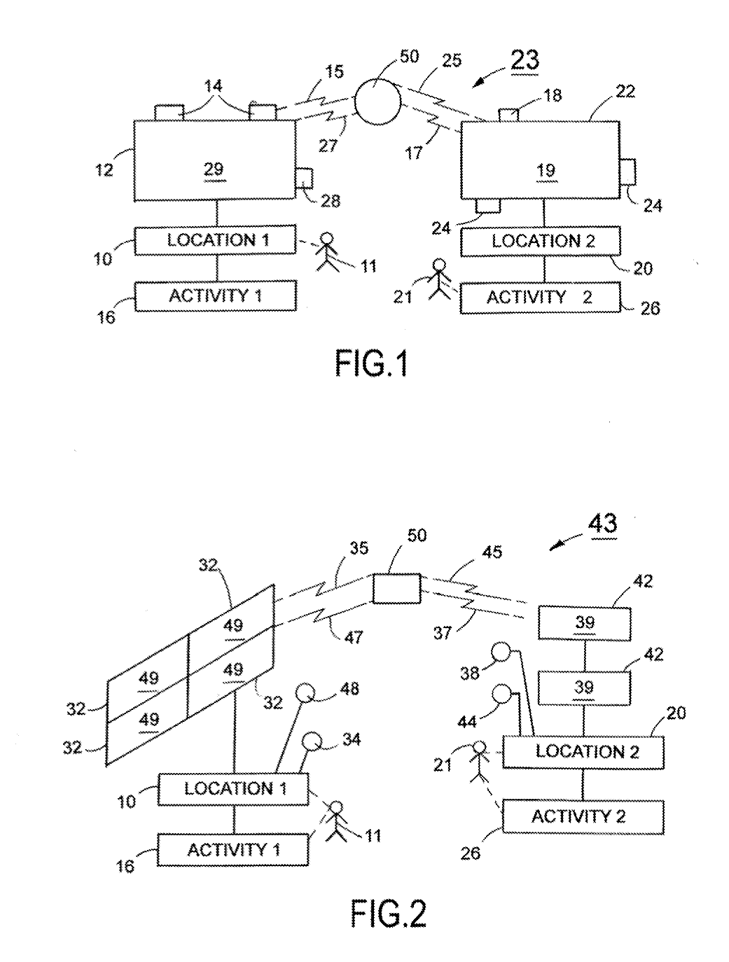

FIG. 1, illustrates a first embodiment of the inventive Distance Mirror Television invention 23 or DMTV 23. The Distance Mirror Television invention 23, comprises at least one first DMTV screen 12, having at least one first camera 14, at at least one first location 10, and at least one second DMTV screen 22, having at least one second camera 24, at at least one second location 20. At the first location 10, there is a first activity 16, which is observable and recordable by at least one first sound and/or image recording device 14, such as a first camera 14, while at second location 20, there is a second activity 26, which is observable and recordable by at least one second sound and/or image recording device 24, such as a second camera 24. At least one first camera 14, automatically and continuously records the first activity 16, at first location 10, in real time, as first content or image 19, and then transmits the first content or image 19, as first transmission 15, to at least one receiving and transmission device 50, or transmitter 50. Similarly, at least one second camera 24, automatically and continuously records the second activity 26, at the second location 20, in real time, as second content or image 29, and then transmits the second content or image 29, as second transmission 25, to the at least one receiving and transmission device 50. The at least one receiving and transmission device 50, after receiving the first content 19, via first transmission 15, automatically and continuously transmits it again as first re-transmission 17, to the second location 20. Similarly, the at least one receiving and transmission device 50, after receiving the second content 29, via second transmission 25, transmits it again as second re-transmission 27, to the first location 10. The first location 10, after receiving the second re-transmission 27, of second content 29, automatically and continuously displays the second content 29, on the first screen 12, in real time. Similarly, the second location 20, after receiving the first re-transmission 17, of first content 19, automatically and continuously displays the first content 19, on the second screen 22, in real time. Thus, as one can appreciate, the first activity 16, from the first location 10, is shown or displayed in real time at the second location 20, on the second screen 22, as content 19, while, the second activity 26, from the second location 20, is shown or displayed in real time at the first location 10, on the first screen 12, as content 29.

It should be appreciated that there is no coordination between an electronic transmission of a first image 19, from a first location 10, and an electronic transmission of a second image 29, from a second location 20, and that there is no coordination between a first activity 16, at a first location 10, and a second activity 26, at a second location 20. It should further be appreciated that a first observer 11, at a first location 10, would only passively observe the second image 29, at the first location 10, while a second observer 21, at a second location 20, would only passively observe the first image 19, at the second location 20, and thus, there would be no cooperation or coordination of content 19, 29, or input 19, 29, or content input 19, 29, between the first observer 11, and the second observer 21. It should also be appreciated that the first observer 11, does not control the transmission 15, of the first image 19, and that the second observer 21, does not control the transmission 25, of the second image 29.

It should be understood that the first person or entity 11, does not control the first transmission 15, of the first content 19, of the first activity 16, from the first location 10, and similarly, the second person or entity 21, does not control the second transmission 25, of the second content 29, of the second activity 26, from the second location 20. However, the first person or entity 11, passively observes the second content 29, at the first location 10, while the second person or entity 21, passively observes the first content 19, at the second location 20.

It is important to understand that once the owner or provider of a DMTV apparatus 23, 43, 65, 75, sets up the DMTV apparatus 23, 43, 65, 75, then from that point onwards, the first content 19, from the first location 10, and the second content 29, from the second location 20, are automatically, and continuously provided, without any active assertion of content control or transmission control by the participants of the first activity 16, or the participants of the second activity 26, or the first observer or person or entity 11, or the second observer or person or entity 21. DMTV's transmission feed would be automatic, continuous, and open-ended in duration. It would only be OFF when being repaired or serviced or readjusted.

It is important to appreciate that there is no selection of activities 16, 26, by cameras 14, 24, and no acceptance or refusal of contents 29, 19, at screens 12, 22. As one can further appreciate, contents 29, 19, have not been chosen or coordinated by any component of DMTV 23, 43, 65, 75.

Moreover, Closed Circuit Television (CCTV), Video Conferencing or Video Chatting (VC), and Distance Mirror Television (DMTV), all differ from one another in that, for example, under CCTV the operator or observer is observing on a screen what a camera is capturing, but at the location of the camera no person sees what the operator or observer is seeing, and thus the operator or observer is the only actual viewer of the content. Under VC both ends of the transmission have a camera, and both ends have a screen, and both participants willingly engage in the transmission and subsequent communication, and thus both participants choose and coordinate a mutual content. Here it should be appreciated that in VC each participant actively watches or receives and assimilates the input from the other participant in order to create responses in the ongoing mutual communication. Whereas, with the DMTV invention 23, neither the person 11, at the first location 10, nor the person 21, at the second location 20, chooses or creates or controls the content that is captured, transmitted, and viewed, at the other location. Here it should further be appreciated that with DMTV, neither participant actively receives and assimilates input from the other participant, and no ongoing mutual content is created or chosen.

It may be appreciated once more that the DMTV invention 23, is intended to mimic the Mirror, wherein an observer can observe an image but cannot communicate with the image. The DMTV invention 23, takes this “mirror concept” to another level, where the first “mirror image” 19, from a first location 10, is electronically sent to a second location 20, and the second “mirror image” 29, from the second location 20, is electronically sent to the first location 10. Thus the first “mirror image” 19, of the first location 10, is not seen at the first location 10, but is seen by an observer 21, at a second location 20, and similarly, the second “mirror image” 29, of the second location 20, is not seen at the second location 20, but is seen by an observer 11, at a first location 10.

It should be appreciated that the DMTV screen 12, 22, 32, 42, 52, 62, is integral to the DMTV effect. The DMTV screen 12, 22, 32, 42, 52, 62, would be available to anyone who enters its field of visibility. The DMTV screen 12, 22, 32, 42, 52, 62, is a “sociable” artifact. One need only look at it to see in real time other people or content in other places, and be seen by them in return. These attributes are unlike the CCTV screen, which is one-way, and unlike the VC screen, which is a personal item that shows what its user chooses from an array of options and operations.

It should be appreciated that DMTV 23, is different from VC (Video Conference, Video Chat). It should be appreciated that with VC, transmission is achieved, maintained, and terminated, by coordinated activity of participants controlling and answering camera(s) and sound recording device(s) and display screen(s). In contrast, with DMTV 23, there is no maintaining of the transmission 15, 50, 25; 17, 50, 27, by any of the participants 11, 21. Given that DMTV camera capture for initial transmission 15, 17, is automatic and continuous and occurs in real time, it may be appreciated that individuals 11, 21, and their activities 16, 26, will be captured by the cameras 14, 24, and transmitted 15, 17, merely when said individuals 11, 21, and said activities 16, 26, are in the range of a DMTV camera 14, 24, in real time. Given that DMTV content display 19, 29, is automatic and continuous and occurs in real time it may be appreciated that any particular content display 19, 29, of any activity 16, 26, is seen by participants 11, 21, who merely have a view of a DMTV screen 12, 22, in real time. Thus with DMTV the activity 16, 26, the activity of observing is a passive activity, occurring merely due to having a line of sight to a DMTV screen 16, 26.

It is important to appreciate that in DMTV 23, 43, 65, 75, with its passive observation of random individuals and random activities, no observer/participant 11, 21, uses the telephone number or IP (Internet Protocol) address or URL (Uniform Resource Locator) or any other electronic dial-in number of any another observer/participant 11, 21, to initiate or establish the DMTV communication 15, 50, 25; 17, 50, 27.

The first location 10, could have one or more people 11, either participating in the first activity 16, or observing the images of broadcast 29, on first screen 12, or both. Similarly, the second location 20, could have one or more people 21, either participating in the second activity 26, or observing the images of broadcast 19, on the second screen 22, or both. It should be appreciated that the first activity 16, or the second activity 26, could be an active activity or a passive activity.

The Distance Mirror Television invention 23, could optionally have at least one second location sound transmitter 28, to transmit background sounds from the second location 20, in conjunction with the display of second content 29. Similarly, the Distance Mirror Television invention 23, could optionally have at least one first location sound transmitter 18, to transmit background sounds from the first location 10, in conjunction with the display of the first content 19. Content 19, 29, could be selected from a group comprising image, sound, video, or any combination thereof.

FIG. 2, illustrates a second embodiment of the inventive Distance Mirror Television invention 43 or DMTV 43. The Distance Mirror Television invention 43, comprises at least one first DMTV screen 32, having at least one first sound and/or image recording device 34, such as a first camera 34, at at least one first location 10, and at least one second DMTV screen 42, having at least one second sound and/or image recording device 44, such as a second camera 44, at at least one second location 20. At first location 10, there is a first activity 16, which is observable and recordable by at least one first camera 34, while at the second location 20, there is a second activity 26, which is observable and recordable by at least one second camera 44. At least one first camera 34, automatically and continuously records the first activity 16, at first location 10, in real time, as first content 39, and then transmits the first content 39, as first transmission 35, to at least one receiving and transmission device 50, or transmitter 50. Similarly, at least one second camera 44, automatically and continuously records the second activity 26, at second location 20, in real time, as second content 49, and then transmits the second content 49, as second transmission 45, to the at least one receiving and transmission device 50. The at least one receiving and transmission device 50, after receiving the first content 39, via first transmission 35, automatically and continuously transmits it again as first re-transmission 37, to the second location 20. Similarly, the at least one receiving and transmission device 50, after receiving the second content 49, via second transmission 45, transmits it again as second re-transmission 47, to the first location 10. The first location 10, after receiving the second re-transmission 47, of second content 49, automatically and continuously displays the second content 49, on the first screen 32, in real time. Similarly, second location 20, after receiving the first re-transmission 37, of first content 39, automatically and continuously displays the first content 39, on the second screen 42, in real time. Thus, as one can appreciate, the first activity 16, at the first location 10, is shown or displayed in real time at second location 20, on second screen 42, while, the second activity 26, at second location 20, is shown or displayed in real time at first location 10, on first screen 32.

The Distance Mirror Television invention 43, could optionally have at least one second location sound transmitter 48, to transmit background sounds from the second location 20, in conjunction with the display of second content 49. Similarly, the Distance Mirror Television invention 43, could optionally have at least one first location sound transmitter 38, to transmit background sounds from the first location 10, in conjunction with the display of the first content 39.

The DMTV display screens 32, could be individual screens 32, a series of screens 32, a cluster of screens 32, to name a few. Similarly, the DMTV display screens 42, could be individual screens 42, a series of screen 42, a separated DMTV screen 42, to name a few.

It should be appreciated that the second content 49, could be displayed on each of the individual screens 32, or a portion of the second content 49, could be displayed on each of the individual screens 32, for example, if there are four screens 32, that are clustered together to form one giant or combined screen 32, then one quarter of second content 49, could be displayed in each of the individual screens 32, which of course will give the first observer 11, a larger or magnified view of the content 49, on the giant or combined screens 32. Display of content on each screen could be preset or preprogrammed as desired by the owner or provider of DMTV.

The camera 14, 24, 34, 44, could be a stand-alone camera or could be attached to or integrated within the screen 12, 22, 32, 42. It is preferred that each camera 14, 24, 34, 44, that is used to capture the image of the activity 16, 26, is placed in such a way as not to be intrusive or make the participants or observers 11, 21, self-conscious in its presence. The image(s) could be selected from a group comprising a still picture, a moving image, a video, to name a few.

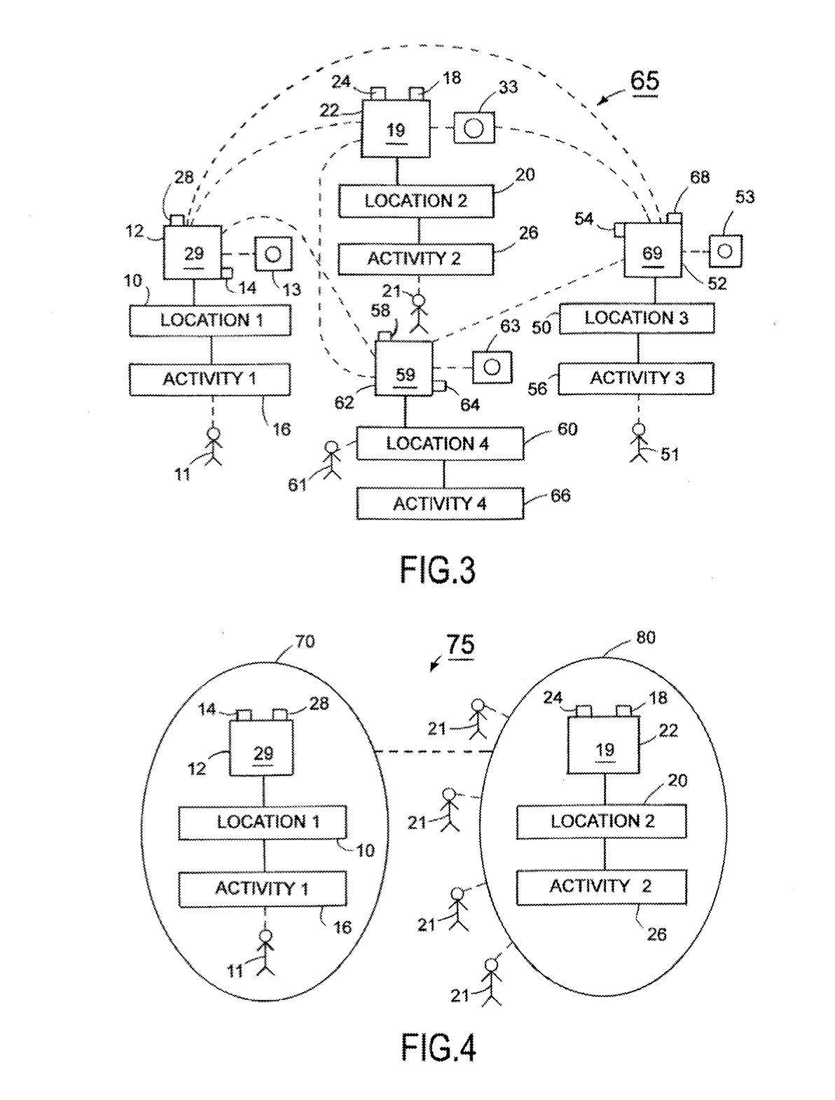

FIG. 3, illustrates a third embodiment of the inventive Distance Mirror Television invention 65 or DMTV 65. The Distance Mirror Television invention 65, is similar the Distance Mirror Television invention 23, 43, as discussed with reference to FIGS. 1, and 2. More specifically the Distance Mirror Television invention 65, comprises at least one first DMTV screen 12, having at least one first camera 14, at at least one first location 10, at least one second DMTV screen 22, having at least one second camera 24, at at least one second location 20, at least one third DMTV screen 52, having at least one third camera 54, at at least one third location 50, and at least one fourth DMTV screen 62, having at least one fourth camera 64, at at least one fourth location 60. At the first location 10, there is a first activity 16, which is observable and recordable by at least one first sound and/or image recording device 14, such as, the at least one first camera 14. Similarly, at second location 20, there is a second activity 26, which is observable and recordable by at least one second sound and/or image recording device 24, such as, the at least one second camera 24. Similarly, at the third location 50, there is a third activity 56, which is observable and recordable by at least one third sound and/or image recording device 54, such as, the at least one third camera 54. Similarly, at fourth location 60, there is a fourth activity 66, which is observable and recordable by at least one fourth sound and/or image recording device 64, such as, the at least one fourth camera 64. Each of the cameras 14, 24, 54, 64, records each of the activities 16, 26, 56, 66, at each of the respective locations 10, 20, 50, 60, as content 19, 29, 69, 59, and then transmits the contents 19, 29, 69, 59, as transmission 15, 25, to at least one receiving and transmission device 50, or transmitter 50, as shown and discussed with reference to FIG. 1. The at least one receiving and transmission device 50, after receiving the content 19, 29, 59, 69, via transmission 15, 25, transmits it again as re-transmission 17, 27, as shown and discussed with reference to FIG. 1. Each of the locations 10, 20, 50, 60, after receiving the second re-transmission 17, 27, of the content 29, 19, 69, 59, displays the content 29, 19, 69, 59, on the appropriate screen 12, 22, 52, 62. Thus, as discussed with reference to FIG. 1, the first activity 16, from the first location 10, is shown or displayed in real time at the second location 20, on the second screen 22, as content 19, while, the second activity 26, from the second location 20, is shown or displayed in real time at the first location 10, on the first screen 12, as content 29. However, with this third embodiment of the inventive Distance Mirror Television invention 65 or DMTV 65 invention, for example, the screen 12, would successively show content 29, 59, 69, etc. Similarly, the screen 22, would successively show content 19, 59, 69, etc., while the screen 52, would successively show content 19, 29, 69, etc., and the screen 62, would successively show content 19, 29, 59, etc. The successive content 19, 29, 59, 69, could be shown in a pattern or in a random manner. Similarly, the successive content 19, 29, 59, 69, could be shown for a fixed time at each display on the screen 12, 22, 52, 62, or could be displayed for a variable or random time on the screen 12, 22, 52, 62. For the purposes of illustration only four locations 10, 20, 50, 60, having screens 12, 22, 52, 62, have been shown in FIG. 3; however, it should be understood that additional locations, screens, activities, cameras, etc., can be easily integrated with the Distance Mirror Television invention 65 or DMTV 65 invention.

Optionally, the Distance Mirror Television invention 65 or DMTV 65 invention could also comprise at least one display item 13, at location 10, and/or at least one display item 33, at location 20, and/or at least one display item 53, at location 50, and/or at least one display item 63, at location 60. When this option is used in conjunction with the Distance Mirror Television invention 23, 43, 65 or DMTV 23, 43, 65, then preferably the content 19, 29, 59, 69, that is displayed on screen 12, 22, 52, 62, of the activity 16, 26, 56, 66, could either be replaced by or be complemented with the display item 13, 33, 53, 63, on the corresponding screens 12, 22, 52, 62. This option would be preset or preprogrammed to operate in a specific manner.

It should be appreciated that DMTV 23, 43, 65, 75, does not accumulate information about its participants 11, 21, 51, 61. DMTV transmission 15, 50, 25; 17, 50, 27, is automatic and continuous, and DMTV content images 19, 29, 59, 69, appear and are replaced in real time. There is no component of DMTV 23, 43, 65, 75, to store, hold in memory, or analyze, information about DMTV participants 11, 21, 51, 61. In this respect, DMTV 23, 43, 65, 75, is different from VC devices, and different from CCTV.

It should be appreciated that DMTV content 29, 19, is not coordinated to suit any particular observer 11, 21, 51, 61. In relation to this fact, it should be appreciated that DMTV 23, 43, 65, 75, does not have algorithms or systems of settings to coordinate activities 16, 26, and their broadcast transmissions 15, 50, 25; 17, 50, 27, with the needs or wishes or tastes of particular observers 11, 21, 51, 61.

The Distance Mirror Television invention 65, could optionally have for one or more locations 10, 20, 50, 60, at least one sound transmitter 18, 28, 58, 68, to transmit background sounds from the originating location 10, 20, 50, 60, in conjunction with the display of the corresponding content 19, 29, 59, 69. Content 19, 29, 59, 69, could be selected from a group comprising image, sound, video, or any combination thereof.

FIG. 4, illustrates a fourth embodiment of the inventive Distance Mirror Television invention 75 or DMTV 75. The Distance Mirror Television invention 75, is similar to the Distance Mirror Television invention 23, 43, 65, as discussed with reference to FIGS. 1, 2, and 3; however, one or more of the location(s) of the Distance Mirror Television invention 75 or DMTV 75, may be on a device 70, 80. For example, location 10, may be on a device 70, while location 20, may be on a device 80. At location 10, the observer 11, may also be on the device 70, while at location 20, the observer 21, may be outside the device 80. Thus at location 10, the observer 11, is contained inside the device 70, and observes the content 29, as the device 70, moves, while at location 20, the observer 21, is outside the device 80, and only observes the content 19, as the device 80, is within the viewing area of the observer 21. The device 70, 80, could be a stationary location or device 70, 80, or could be a non-stationary location or device 70, 80. The non-stationary location or device 70, could be selected from a group comprising a moving platform, an airplane, a blimp, a helicopter, a rocket, a space vehicle, a space station, a train, a ship, a car, a bus, a boat, a vehicle, to name a few. The non-stationary location or device 80, could be selected from a group comprising a moving platform, a train, a ship, a car, a bus, a boat, a vehicle, a moving billboard, a display device on tracks, a display device on wheels, to name a few. It should be appreciated that the various DMTV components are not preset or programmed or controlled by the operator of any moving location or moving device itself.

Screens 12, 22, 32, 42, 52, 62, could be individual screens or a cluster of screens or separately positioned screens. The screens 12, 22, 32, 42, 52, 62, could be mounted at a human eye level or they could be mounted above a human eye level, such as, for example, on a pedestal, on the side of a wall, on the side of a building, on the side of a structure, hung from a ceiling, hung from a platform, to name a few. The screens 12, 22, 32, 42, 52, 62, also could be built into the outside or inside of a building or other structure. It should be appreciated that the screens 12, 22, 32, 42, 52, 62, have associated therewith at least one camera 14, 24, 34, 44, 54, 64, and, if audio is to be used, at least one speaker or sound producing device 18, 28, 38, 48, 58, 68. For some applications each of these devices, namely, camera 14, 24, 34, 44, 54, 64, and/or speaker or sound producing device 18, 28, 38, 48, 58, 68, could either be securely attached to the corresponding screens 12, 22, 32, 42, 52, 62, or be electronically or wirelessly connected to the corresponding screens 12, 22, 32, 42, 52, 62.

The at least one receiving and transmission device 50, could be selected from a group comprising a wireless receiving and transmitting device 50, a wired receiving and transmitting device 50, the Internet 50, a communication satellite 50, to name a few.

As discussed earlier “Distance Mirror Television” 23, 43, 65, 75, or DMTV 23, 43, 65, 75, uses closed transmission in the format of the mirror. With the DMTV invention 23, 43, 65, 75, the plane mirror, with its onlooker and reflection, is replaced by mutual observation between two or more individuals 11, 21, 51, 61, at different locations 10, 20, 50, 60.

Plane-Mirror-like elements of DMTV 23, 43, 65, 75, may include: no change in vantage point; no elaborated outputs, i.e., no zoom, no pan, etc.; [implied] frame; human recognition, to name a few.

Distance Mirror Television could be used silently for particular effects having similarities to the experience of looking in a mirror.

Distance Mirror Television (DMTV) 23, 43, 65, 75, could provide a succession of content images 29, 19, 59, 69, etc., each providing mutual observation between individuals 11, 21, 51, 61, at different locations 10, 20, 50, 60.

Distance Mirror Television (DMTV) 23, 43, 65, 75, could provide real-time live mutual observation to individual(s) at stationary or at non-stationary locations.

It should be appreciated that there is no DMTV cooperation or DMTV coordination between the individuals 11, 21, 51, 61, whether they are observing or being observed.

Distance Mirror Television 23, 43, 65, 75, could be used in public 10, 20, 50, 60, semi-public 10, 20, 50, 60, and private places 10, 20, 50, 60.

At each location 10, 20, 50, 60, it is recommended that the Distance Mirror Television (DMTV) 23, 43, 65, 75, and all its components be properly protected from the environment and the elements, such as, for example, snow, rain, heat, high winds, sun glare, to name a few. Additionally, it is envisioned that the cost of manufacture, installation, operation, and maintenance of the DMTV system 23, 43, 65, 75, should be reasonable and cost-effective.

It should be appreciated that mutuality of observation in the distance mirror television (DMTV) format 23, 43, 65, 75, could be provided in locations 10, 20, 50, 60, selected from a group comprising houses, dwellings, hotels, clubs, stores, shopping locations, marketplaces, schools, workplaces, gathering places, meeting places, worldwide locations, publicly owned locations, privately owned locations, commercial locations, recreational locations, natural locations, man-made locations, and combinations thereof, to name a few.

It should be appreciated that DMTV activities 16, 26, 56, 66, could be selected from a group comprising a nature scene, an urban scene, a rural scene, a domestic scene, a commercial activity, a work activity, a recreational activity, a sports activity, a human observing activity, an animal observing activity, an art activity, and combinations thereof, to name a few.

The DMTV invention could use a split-screen concept or a picture-in-picture concept with this invention 23, 43, 65, 75, especially while showing display-item content 19, 29, 39, 49, 59, 69, on screens 12, 22, 32, 42, 52, 62. This option would be preset or preprogrammed.

The following examples are provided to further illustrate the invention and are not intended to be limiting thereof:

### Example 1

### Mutual Feeds at Iconic Locations

On a building in Times Square 10, a giant screen 12, DMTV displays a feed 29, coming from a ground level area 20, at the base of the Eiffel Tower 20. Reciprocally, a DMTV feed 19, on a giant screen 22, on the lower structure of the Eiffel Tower 20, receives its transmission 17, from the ground level viewing area in Times Square 10. The crowd 11, 21, in each location 10, 20, is looking up and looking at a live broadcast 29, 19, of the other crowd 11, 21, in the other place 10, 20. Each crowd 11, 21, sees the other location 10, 20, and the other crowd 11, 21. For some applications, such as this one, the actual size of the DMTV image 19, 29, preferably needs to be larger than life in order to be experienced properly from below, as both the screens 12, 22, may be placed at a height.

### Example 2

### Alongside a Sidewalk

Alongside a sidewalk in Chicago 10, there is a block-long, one-story-high DMTV feed 29, from Jaipur 20, and similarly in Jaipur 20, a feed 19, from Chicago 10: the Jaipuris 21, and Chicagoans 11, alongside one another life-size real-time, the two singular locales 10, 20, being present in the other place 20, 10, would approach the experience of being in two places at the same time.

### Example 3

### In Lobbies

In the lobby of one hotel 10, and the lobby of a hotel somewhere else 20, large DMTV panels 12, 22, would provide real-time mutual transmission 19, 29, opening out each lobby into the other hotel.

### Example 4

### In Schools

With DMTV 23, 43, in the corridors of two schools 10, 20, in two different places 10, 20, children 11, 21, could walk alongside each other, “mirrored,” “in” the other place and “with” the other children.

### Example 5

### In Private Homes

In the entrance to my house 10, and in my friend's entranceway 20, we could have “mirrors” which are really DMTV screens 12, 22, respectively. Each DMTV “mirror” 12, 22, shows a continuous view of the other person's entranceway. Whenever both of us 11, 21, are standing before our “mirror” 12, 22, we see each other 21, 11.

### Example 6

### In Conflict Areas

In two places 10, 20, that are hostile towards each other, the continuous mutual mirrors of DMTV 12, 22, are installed in normal settings such as street, market.

The “mirror”-like effect of DMTV 23, 43, comes in part from the ordinariness of the placement of DMTV panels 12, 22, 32, 42, (at a street, on a wall) and the ordinariness of passing in front of them.

### Example 7

### Within Homes

Part of a wall in a room in one home 10, and similarly in another home 20, could be a DMTV panel 12, 22, 32, 42. These homes 10, 20, could be anywhere in the world. The feed 19, 29, in private homes 10, 20, could be turned on and off.

### Example 8

### Silent Use

The particular method of use envisioned for various circumstances, including but not limited to Examples 1-7 above, is video without audio. Silent use is envisioned as a method to heighten the mutual distance-mirror effect by replicating the silence of mirrors and the silence of the experience of looking into mirrors.

Designers and architects could incorporate Distance Mirror Television 23, 43, in their work. No artist is needed for Distance Mirror Television to take place. But artists, designers, architects, could create incorporations of Distance Mirror Television, just as artists, designers, and architects have made incorporations of the mirror.

### Example 9

### Remote and Inhabited Locations

Distance Mirror Television 23, 43, could be used at a remote location 10, 20, where few or no observers are present or where only non-human “observers” are present, or at an inhabited location 10, 20. For example, the first location 10, could be a remote location 10, such as, a forest 10, a mountain 10, an Arctic region 10, a pond 10, a deep ocean location 10, where natural activity 19, is taking place, while the second location could be an exhibit hall 20, or a lobby 20, or a private home 20, where individuals 21, are present or are mingling 29. Thus, the few or occasional observer(s) 11, or non-human “observer(s)” 11, at the remote location 10, would be seeing the group 29, of individuals 21, at the exhibit hall 20, lobby 20, or private home 20, to name a few examples, while the second observer(s) 21, would be seeing the natural activity 19, at the remote location 10, and also seeing the few or occasional observer(s) 11, or non-human “observer(s)” 11, at the remote location.

### Example 10

### In Stores or Shopping Locations

Customers 11, at a first Name store 10, in a first city 10, or first country 10, or first continent 10, and customers 21, at a second Name store 20, in a second city 20, or second country 20, or second continent 20, see each other as they shop. This use of Distance Mirror Television 23, 43, creates high interest.

### Example 11

### Successive Mutual Observation

In New York, a customer 11, sees a pair of women's shoes 13, showcased in a Name store 10. Behind the pair of shoes 13, is a DMTV panel 12, providing successive broadcast content 29, 59, from branches of the same Name store in Paris 20, and Dubai 50, where the same pair of shoes 33, 53, is also showcased in front of a DMTV panel 22, 52. DMTV images 29, 19, 69, appear on screen 12, 22, 52, at each store 10, 20, 50, and remain for a while in succession. Thus, various women 11, 21, 51, in New York 10, Paris 20, Dubai 50, are looking at each other in real time, successively, contemplating buying that pair of shoes 13, 33, 53.

Incorporating virtual personal encounters into Shopping adds interest and stimulus, and also lends allure to the merchandise itself and to the shopping venue(s). Department stores, chain stores, luxury stores, duty-free stores, shopping malls, all have Creative Directors who could innovate incorporations of DMTV.

### Example 12

### For a Worldwide Product

A worldwide beverage is sold at a location in New York City, and at a location in a city in Azerbaijan. Those two locations are paired up, and each offers a video screen—which need be no larger than a medium-size TV monitor—that is a continuous mutual mirror with another mutual mirror at the other location. Patrons can always take a look at activity in the faraway site, while knowing that they see one another as long as they are within the scope of the mirror (actually, of the camera). A thousand of these DMTV matchups into pairs of locations all over the world could exist under the auspices of a worldwide product.

### Example 13

### Moving Locations

A vehicle 70, 80, equipped with screen 12, camera 14, and optionally, sound recording device 14, and sound transmitting device 28, moves slowly through a remote inhabited region 10. At another DMTV location 20, a group of individuals 21, constitute an audience 21. Observers 11, along the route of the vehicle 70, 80, and observers 21, at the “audience” constitute a mutual DMTV circuit.

A vehicle 70, 80, equipped with screen 12, and camera 14, moves slowly through a supermarket 10, in Toronto, Canada. Another vehicle 70, 80, equipped with screen 22, and camera 24, moves slowly through a marketplace 20, in Cuzco, Peru. People 11, 21, in each location 10, 20, mutually observe each other and each others' surroundings.

### Example 14

### Observation of Activity

At a DMTV location 10, a factory, a showroom, a laboratory, to name a few, an activity 16, is taking place. At another DMTV location 20, a group of people constitute an audience 21. Participants 11, in the activity 16, and members of the “audience” 21, form a DMTV circuit. It should be understood that this is passive observation, and that there is no cooperation or coordination between individuals, whether they are observing or being observed from one location 10, to the other location 20.

The above Examples are for illustration purposes only, and the numerals used in the Figures and the corresponding text are illustrative only. However, it should be understood that any combination of inventive ideas disclosed in FIGS. 1-4, can be used in conjunction with any of the above Examples. Similarly, one or more of the above Examples can be combined to further illustrate the invention.

While the present invention has been particularly described in conjunction with a specific preferred embodiment, it is evident that many alternatives, modifications, and variations will be apparent to those skilled in the art in light of the foregoing descriptions. It is therefore contemplated that the appended claims will embrace any such alternatives, modifications and variations as falling within the true scope and spirit of the present invention.

What is claimed is:

1. A distance mirror television apparatus, comprising:
(a) at least one first location having at least one first screen, and wherein said at least one first location has at least one first camera to record and transmit at least one first image of at least one first activity to at least one transmitter;
(b) at least one second location having at least one second screen, and wherein said at least one second location has at least one second camera to record and transmit at least one second image of at least one second activity to said at least one transmitter;
(c) said transmitter having at least one means to transmit said at least one first image to said at least one second screen at said at least one second location, and wherein said at least one second screen has at least one means to display said at least one first image at said at least one second location;
(d) said transmitter having at least one means to transmit said at least one second image to said at least one first screen at said at least one first location, and wherein said at least one first screen has at least one means to display said at least one second image at said at least one first location;
(e) wherein there is no coordination between transmission of said at least one first image, and transmission of said at least one second image;
(f) wherein there is no coordination between said at least one first activity, and said at least one second activity, and
(g) wherein there is passive observation of said at least one first activity at said second location, and a passive observation of said at least one second activity at said first location.

2. The distance mirror television apparatus of claim 1, wherein said at least one first location has at least one means to broadcast sounds originating from said at least one second location.

3. The distance mirror television apparatus of claim 1, wherein said at least one first location has at least one means to broadcast sounds originating from said at least one second location.

4. The distance mirror television apparatus of claim 1, wherein said at least one second location has at least one means to broadcast sounds originating from said at least one first location.

5. The distance mirror television apparatus of claim 1, wherein said at least one second location has at least one means to broadcast sounds originating from said at least one first location, and wherein said sounds are of said at least one first activity.

6. The distance mirror television apparatus of claim 1, wherein said transmitter receives said at least one first image and said at least one second image via a transmission means, and wherein said transmission means are selected from a group consisting of wired transmission means, wireless transmission means, Internet means, and satellite transmission means.

7. The distance mirror television apparatus of claim 1, wherein said at least one first activity is selected from a group consisting of a nature scene, an urban scene, a rural scene, a domestic scene, a commercial activity, a work activity, a recreational activity, a sports activity, a human observing activity, an animal observing activity, an art activity, and combinations thereof.

8. The distance mirror television apparatus of claim 1, wherein said at least one second activity is selected from a group consisting of a nature scene, an urban scene, a rural scene, a domestic scene, a commercial activity, a work activity, a recreational activity, a sports activity, a human observing activity, an animal observing activity, an art activity, and combinations thereof.

9. The distance mirror television apparatus of claim 1, wherein place for said at least one first activity is selected from a group consisting of a public place, a semi-public place, and a private place.

10. The distance mirror television apparatus of claim 1, wherein place for said at least one second activity is selected from a group consisting of a public place, a semi-public place, and a private place.

11. The distance mirror television apparatus of claim 1, wherein at least one first individual observes said at least one second activity on said at least one first screen at said at least one first location, while at least one second individual observes said at least one first activity on said at least one second screen at said at least one second location.

12. The distance mirror television apparatus of claim 1, wherein at least one first individual observes said at least one second individual on said at least one first screen at said at least one first location, while at least one second individual observes said at least one first individual on said at least one second screen at said at least one second location.

13. The distance mirror television apparatus of claim 1, wherein mutuality of observation is provided in said distance mirror television (DMTV) format in locations selected from a group consisting of houses, dwellings, hotels, clubs, stores, shopping locations, marketplaces, schools, workplaces, gathering places, meeting places, worldwide locations, publicly owned locations, privately owned locations, commercial locations, recreational locations, natural locations, and man-made locations.

14. The distance minor television apparatus of claim 1, wherein live mutual observation is provided in place of mirror self-observation.

15. The distance mirror television apparatus of claim 1, wherein video without audio is used.

16. The distance mirror television apparatus of claim 1, wherein said apparatus has at least one means to provide successive live mutual observations between a succession of locations.

17. The distance mirror television apparatus of claim 1, wherein said apparatus has at least one means to provide live mutual observation at a location selected from a group consisting of a stationary location, and a non-stationary location.

18. The distance mirror television apparatus of claim 1, wherein said apparatus has at least one means to provide live mutual observation at at least one non-stationary location, and wherein said at least one non-stationary location is selected from a group consisting of a moving platform, an airplane, a blimp, a helicopter, a rocket, a space vehicle, a space station, a train, a ship, a car, a bus, a boat, a vehicle, a moving billboard, a display device on wheels, and a display device on tracks.

19. The distance mirror television apparatus of claim 1, wherein said transmitter is selected from a group consisting of a wireless receiving and transmitting device, a wired receiving and transmitting device, the Internet, and a communication satellite.

20. The distance mirror television apparatus of claim 1, wherein said at least one first screen is selected from a group consisting of an individual screen, a series of screens, a cluster of screens, and separated screens.

21. The distance mirror television apparatus of claim 1, wherein said at least one second screen is selected from a group consisting of an individual screen, a series of screens, a cluster of screens, and separated screens.

22. The distance mirror television apparatus of claim 1, wherein at least one of said at least one first screen has securely associate thereto said at least one first camera, and at least one first sound producing device.

23. The distance mirror television apparatus of claim 1, wherein at least one of said at least one second screen has securely associate thereto said at least one second camera, and at least one second sound producing device.

24. The distance mirror television apparatus of claim 1, wherein said at least one first image and said at least one second image is selected from a group consisting of a still picture, a moving image, and a video.

25. A distance mirror television apparatus, comprising:
(a) at least one first location having at least one first screen, and wherein said at least one first location has at least one first camera to record and transmit at least one first image of at least one first activity to at least one transmitter;
(b) at least one second location having at least one second screen, and wherein said at least one second location has at least one second camera to record and transmit at least one second image of at least one second activity to said at least one transmitter;
(c) said transmitter having at least one means to transmit said at least one first image to said at least one second screen at said at least one second location, and wherein said at least one second screen has at least one means to display said at least one first image at said at least one second location;
(d) said transmitter having at least one means to transmit said at least one second image to said at least one first screen at said at least one first location, and wherein said at least one first screen has at least one means to display said at least one second image at said at least one first location;
(e) at least one first individual at said at least one first location observes said at least one second activity on said at least one first screen at said at least one first location;
(f) at least one second individual at said at least one second location observes said at least one first activity on said at least one second screen at said at least one second location;
(g) wherein there is no coordination between transmission of said at least one first image, and transmission of said at least one second image;
(h) wherein there is no coordination between said at least one first activity, and said at least one second activity;
(i) wherein said at least one first individual does not control said first transmission, and wherein said at least one second individual does not control said second transmission; and
(j) wherein there is passive observation of said at least one first activity at said second location by said second individual, and a passive observation of said at least one second activity at said first location by said first individual.

26. A method to operate a distance mirror television, comprising the steps of:
(a) providing at least one first screen and at least one first camera at at least one first location;
(b) providing at least one means to said at least one first camera to record and transmit at least one first image of at least one first activity taking place at said at least one first location to at least one transmitter;
(c) providing at least one second screen and at least one second camera at at least one second location;
(d) providing at least one means to said at least one second camera to record and transmit at least one second image of at least one second activity taking place at said at least one second location to said at least one transmitter;
(e) providing at least one means to said at least one transmitter to transmit said at least one first image of said at least one first activity to said at least one second screen at said at least one second location;
(f) providing at least one means to said at least one second screen to display said at least one first image of said at least one first activity at said at least one second location;
(g) providing at least one means to said at least one transmitter to transmit said at least one second image of said at least one second activity to said at least one first screen at said at least one first location;
(h) providing at least one means to said at least one first screen to display said at least one second image of said at least one second activity at said at least one first location;
(i) at least one first individual at said at least one first location observing said at least one second activity on said at least one first screen at said at least one first location;
(j) at least one second individual at said at least one second location observing said at least one first activity on said at least one second screen at said at least one second location;
(k) wherein there is no coordination between transmission of said at least one first image and transmission of said at least one second image;
(l) wherein there is no coordination between said at least one first activity and said at least one second activity;
(m) wherein said at least one first individual does not control said first transmission, and wherein said at least one second individual does not control said second transmission; and
(n) wherein there is passive observation of said at least one first activity at said second location by said second individual, and a passive observation of said at least one second activity at said first location by said first individual.

27. The method to operate a distance mirror television of claim 26, wherein said at least one first activity and said at least one second activity are random activities.

28. The method to operate a distance mirror television of claim 26, wherein neither said at least one first individual nor said at least one second individual utilizes a method selected from a group consisting of a telephone number, an IP (Internet Protocol) address, a URL (Uniform Resource Locator), and an electronic dial-in number, to establish said passive observation.
